(19) United States
(12) Patent Application Publication
(10) Pub. No.: US 2025/0254575 A1
(43) Pub. Date: Aug. 7, 2025

(54) METHOD AND APPARATUS FOR A SOFT SATELLITE SWITCHING PROCEDURE

(71) Applicant: APPLE INC., CUPERTINO, CA (US)

(72) Inventors: Fangli XU, CUPERTINO, CA (US); Ji CUI, CUPERTINO, CA (US); Dawei ZHANG, CUPERTINO, CA (US); Yuqin CHEN, CUPERTINO, CA (US); Chunhai YAO, CUPERTINO, CA (US); Haijing HU, CUPERTINO, CA (US); Chunxuan YE, CUPERTINO, CA (US); Yang TANG, CUPERTINO, CA (US); Wei ZENG, CUPERTINO, CA (US)

(21) Appl. No.: 18/839,136

(22) PCT Filed: Sep. 28, 2023
(86) PCT No.: PCT/CN2023/122420

§ 371 Date: Aug. 16, 2024

(30) Foreign Application Priority Data
Sep. 28, 2023 (WO) PCT/CN2023/122420

(51) Int. Cl. H04W 36/00; H04W 36/08

(52) U.S. Cl. CPC H04W 36/00725; H04W 36/083

(57) ABSTRACT

Embodiments relate to a method and apparatus for a soft satellite switching procedure. A method for a user equipment (UE) in communication with a source satellite to switch to a target satellite includes the following operations: receiving a signal from the source satellite; and determining whether to switch to the target satellite based upon a hard switch or a soft switch.

### FIELD OF INVENTION

This invention relates generally to the field of wireless communication, and more particularly, to a method and apparatus for a soft satellite switching procedure.

### BACKGROUND OF THE INVENTION

In a wireless communications network, user equipment (UE) may communicate with a base station of the network by establishing a radio link between the UE and the base station. In a 5G (New Radio or NR) or 4G (LTE) wireless network, a UE may receive signaling and data from the serving base station in a downlink (DL) transmission direction or transmit signaling and data to the serving base station in an uplink (UL) transmission direction. Further, Non-Terrestrial Networks (NTNs) referring to networks, or segments of networks, that use airborne or spaceborne vehicles (e.g., satellites) for DL and UL transmission with UEs are increasingly being utilized.

### SUMMARY OF THE DESCRIPTION

Various 3GPP meeting groups have agreed to support both hard and soft satellite (SAT) switching (e.g., NTN vehicles) for UEs. However, there are many open issues that need to be resolved in order to fully support hard and soft SAT switching for UEs.

Embodiments relate to a method and apparatus for a soft satellite switching procedure. In particular, one embodiment relates to a method for a user equipment (UE) in communication with a source satellite to switch to a target satellite that includes the following operations: receiving a signal from the source satellite; and determining whether to switch to the target satellite based upon a hard switch or a soft switch. In one embodiment, the method further includes: determining whether to switch to the target satellite based upon a hard switch or a soft switch that is based upon a received network configuration message from a network comprising an explicit indication for hard or soft switching or an implicit indication including whether a measurement gap is configured. In one embodiment, the measurement gap is configured for soft switching or no measurement gap for hard switching. In one embodiment, the received network configuration message from the network comprises a system information block (SIB) including information about a cell of the target satellite to perform the soft switch to. In one embodiment, during the soft switch, the method further includes acquiring downlink (DL) synchronization with the target satellite. In one embodiment, when the measurement gap comprises a stop time of the source satellite that exceeds the start time of the target satellite, the method further includes causing a command for the performing of a soft switch to a cell of the target satellite.

In another type of embodiment, a user equipment (UE) in communication with a source satellite to switch to a target satellite is disclosed. The UE comprises: at least one antenna; at least one radio, wherein the at least one radio is configured to communicate with the source satellite and the target satellite using the at least one antenna; and at least one processor coupled to the at least one radio. The at least one processor is configured to perform operations comprising: receiving a signal from the source satellite; and determining whether to switch to the target satellite based upon a hard switch or a soft switch. In one embodiment, determining whether to switch to the target satellite based upon a hard switch or a soft switch is based upon a received network configuration message from the network comprising an explicit indication for hard or soft switching or an implicit indication including whether a measurement gap is configured. In one embodiment, the measurement gap is configured for soft switching or no measurement gap for hard switching. In one embodiment, the received network configuration message from the network comprises a system information block (SIB) including information about a cell of the target satellite to perform the soft switch to. In one embodiment, during the soft switch, the processor commands performing downlink (DL) synchronization with the target satellite. In one embodiment, when the measurement gap comprises a stop time of the source satellite that exceeds the start time of the target satellite, the processor commands the performing of a soft switch to a cell of the target satellite.

In another type of embodiment, a method for a user equipment (UE) in communication with a source satellite to switch to a target satellite is disclosed that includes: switching communication from the source satellite to the target satellite; and determining whether to utilize a random access channel (RACH)-based communication or a RACH-less communication to access the target satellite. In one embodiment, determining whether to utilize RACH-based communication or RACH-less communication is based upon a received network configuration message from a network. In one embodiment, the received network configuration message from the network to utilize RACH-based communication or RACH-less communication is included in a system information block (SIB) or radio resource control (RRC) dedicated signaling. In one embodiment, the RACH-based or RACH-less configuration is cell specific or target satellite specific. In one embodiment, determining whether to utilize RACH-based communication or RACH-less communication is based upon a status of a timing advance (TA) timer. In one embodiment, if the TA timer is running, RACH-less access to the target satellite is performed. In one embodiment, if the TA timer is expired, RACH-based access to the target satellite is performed. In one embodiment, determining whether to utilize RACH-based communication or RACH-less communication is based upon a difference of downlink propagation delay (PDD) of the target satellite and source satellite. In one embodiment, if the difference of the PDD is less than a threshold, RACH-less access of the target satellite is performed, whereas, if the difference of the PDD is greater than or equal to the threshold, RACH-based access of the target satellite is performed. In one embodiment, determining whether to utilize RACH-based communication or RACH-less communication is based upon radio quality. In one embodiment, if the radio quality of the target SAT is greater than a threshold, RACH-less access of the target satellite is performed, otherwise, RACH-based access of the target satellite is performed.

In another type of embodiment, a user equipment (UE) in communication with a source satellite to switch to a target satellite is disclosed. The UE comprises: at least one antenna; at least one radio, wherein the at least one radio is configured to communicate with the source satellite and the target satellite using the at least one antenna; and at least one processor coupled to the at least one radio. The at least one processor is configured to perform operations comprising: switching communication from the source satellite to the target satellite; and determining whether to utilize a random access channel (RACH)-based communication or a RACH-less communication to access the target satellite. In one embodiment, determining whether to utilize RACH-based communication or RACH-less communication is based upon a received network configuration message from a network. In one embodiment, the received network configuration message from the network to utilize RACH-based communication or RACH-less communication is included in a system information block (SIB) or radio resource control (RRC) dedicated signaling. In one embodiment, the RACH-based or RACH-less configuration is cell specific or target satellite specific. In one embodiment, determining whether to utilize RACH-based communication or RACH-less communication is based upon a status of a timing advance (TA) timer. In one embodiment, if the TA timer is running, RACH-less access to the target satellite is performed. In one embodiment, if the TA timer is expired, RACH-based access to the target satellite is performed. In one embodiment, determining whether to utilize RACH-based communication or RACH-less communication is based upon a difference of downlink propagation delay (PDD) of the target satellite and source satellite. In one embodiment, if the difference of the PDD is less than a threshold, RACH-less access of the target satellite is performed, whereas, if the difference of the PDD is greater than or equal to the threshold, RACH-based access of the target satellite is performed. In one embodiment, determining whether to utilize RACH-based communication or RACH-less communication is based upon radio quality. In one embodiment, if the radio quality of the target SAT is greater than a threshold, RACH-less access of the target satellite is performed, otherwise, RACH-based access of the target satellite is performed.

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1 illustrates an example wireless communication system according to one embodiment of the disclosure.

FIG. 2 illustrates user equipment in direct communication with a base station (BS) according to one embodiment of the disclosure.

FIG. 3 illustrates an example block diagram of a UE according to one embodiment of the disclosure.

FIG. 4 illustrates an example block diagram of a BS according to one embodiment of the disclosure.

FIG. 5 illustrates an example block diagram of cellular communication circuitry according to one embodiment of the disclosure.

FIG. 6A illustrates an example diagram of a hard SAT switching example according to one embodiment of the disclosure.

FIG. 6B illustrates an example diagram of a soft SAT switching example according to one embodiment of the disclosure.

FIG. 6C illustrates an example flowchart to show a method for a UE 106 in communication with a source satellite to switch to target satellite according to one embodiment of the disclosure.

FIG. 7A illustrates an example diagram of a UE switching to a target SAT during a soft SAT switching period according to one embodiment of the disclosure.

FIG. 7B illustrates an example diagram of a DL sync detection failure of the target SAT to the UE during a soft SAT switching period according to one embodiment of the disclosure.

FIG. 8 illustrates an example diagram of UE switching to a target SAT based on a RACH-less communication or RACH-based communication according to one embodiment of the disclosure.

FIG. 9 illustrates an example flowchart to show a method for a UE in communication with a source satellite to switch to target satellite according to one embodiment of the disclosure.

### DETAILED DESCRIPTION

In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “some embodiments” or “an embodiment” means that a particular feature, structure, or characteristic described in connection with the embodiment can be included in at least one embodiment of the invention. The appearances of the phrase “in some embodiments” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

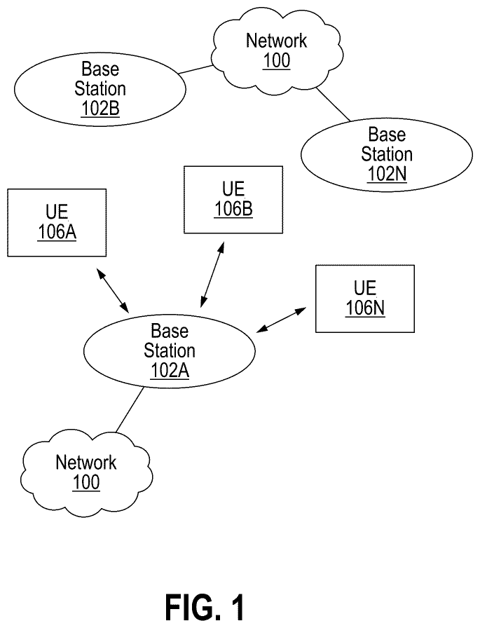

FIG. 1 illustrates a simplified example wireless communication system according to one aspect of the disclosure. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1xRTT, 1xEV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

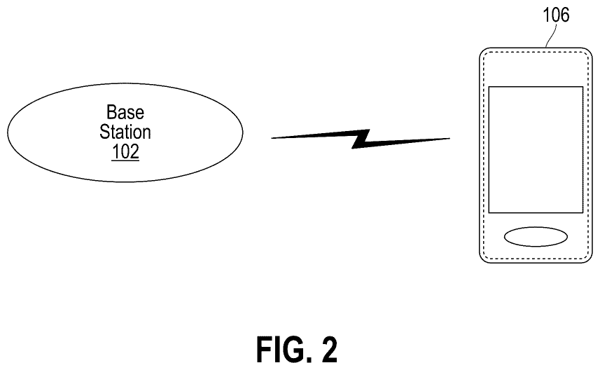

FIG. 2 illustrates a UE 106 in direct communication with a base station 102 through uplink and downlink communications according to one aspect of the disclosure. The UE 106 may be a device with cellular communication capability such as a mobile phone, a hand-held device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1xRTT or LTE or GSM), and separate radios for communicating using each of Wi-Fi and Bluetooth. Other configurations are also possible.

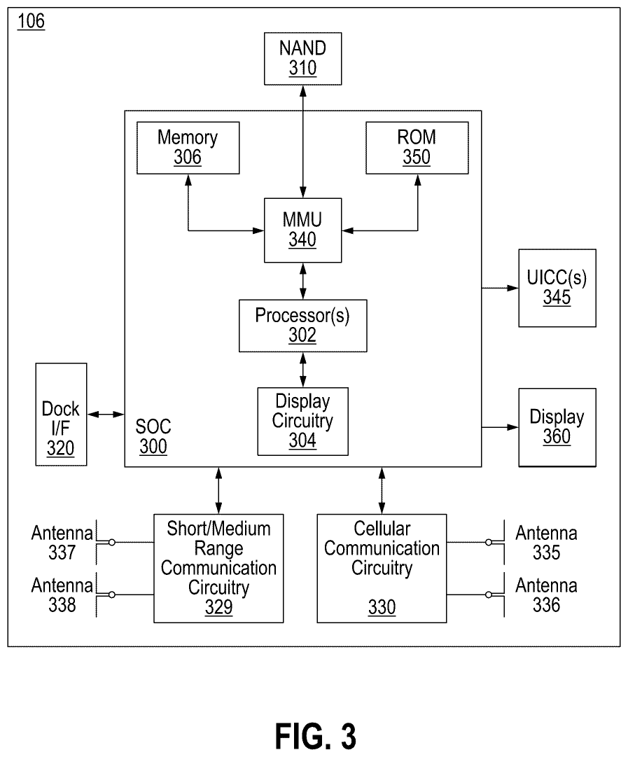

FIG. 3 illustrates an example simplified block diagram of a communication device 106 according to one aspect of the disclosure. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly. dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may also be configured to determine a physical downlink shared channel scheduling resource for a user equipment device and a base station. Further, the communication device 106 may be configured to group and select CCs (component carriers) from the wireless link and determine a virtual CC from the group of selected CCs. The wireless device may also be configured to perform a physical downlink resource mapping based on an aggregate resource matching patterns of groups of CCs.

As described herein, the communication device 106 may include hardware and software components for implementing the above features for determining a physical downlink shared channel scheduling resource for a communications device 106 and a base station. The processor 302 of the communication device 106 may be configured to implement part or all of the features described herein, e.g., by executing program instructions stored on a memory medium (e.g., a non-transitory computer-readable memory medium). Alternatively, (or in addition), processor 302 may be configured as a programmable hardware element, such as an FPGA (Field Programmable Gate Array), or as an ASIC (Application Specific Integrated Circuit). Alternatively, (or in addition), the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short range wireless communication circuitry 329 may include one or more ICs that are configured to perform the functions of short range wireless communication circuitry 32. In addition, each integrated circuit may include circuitry (e.g., first circuitry, second circuitry, etc.) configured to perform the functions of short range wireless communication circuitry 329.

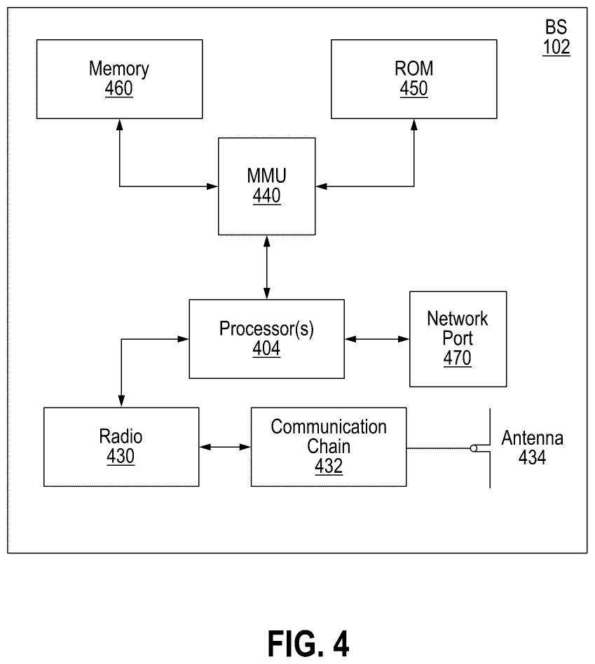

FIG. 4 illustrates an example block diagram of a base station 102 according to one aspect of the disclosure. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UEs 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UEs 106. In some cases, the network port 470 may couple to a telephone network via the core network, and/or the core network may provide a telephone network (e.g., among other UEs serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UEs 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively, (or in addition), the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

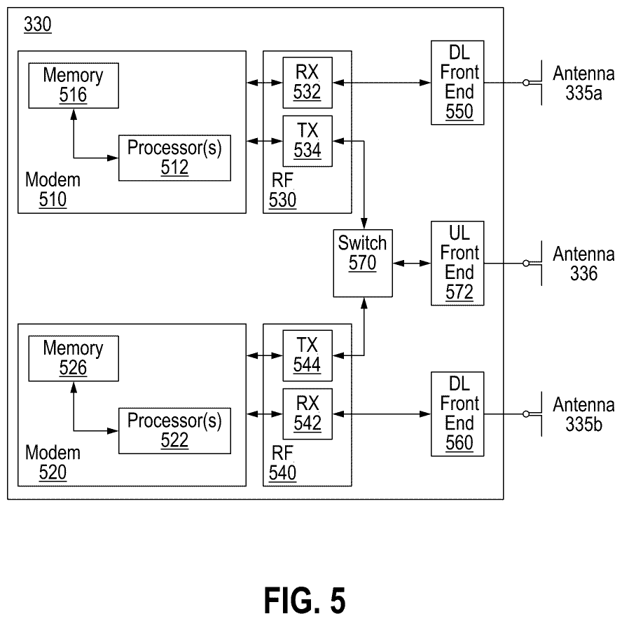

FIG. 5 illustrates an example simplified block diagram of cellular communication circuitry according to one aspect of the disclosure. It is noted that the block diagram of the cellular communication circuitry of FIG. 5 is only one example of a possible cellular communication circuit. According to embodiments, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335 a-b and 336 as shown (in FIG. 3). In some embodiments, cellular communication circuitry 330 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for selecting a periodic resource part for a user equipment device and a base station, as well as the various other techniques described herein. The processors 512 may be configured to implement part or all of the features described herein, e.g., by executing program instructions stored on a memory medium (e.g., a non-transitory computer-readable memory medium). Alternatively, (or in addition), processor 512 may be configured as a programmable hardware element, such as an FPGA (Field Programmable Gate Array), or as an ASIC (Application Specific Integrated Circuit). Alternatively, (or in addition), the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for selecting a periodic resource on a wireless link between a UE and a base station, as well as the various other techniques described herein. The processors 522 may be configured to implement part or all of the features described herein, e.g., by executing program instructions stored on a memory medium (e.g., a non-transitory computer-readable memory medium). Alternatively, (or in addition), processor 522 may be configured as a programmable hardware element, such as an FPGA (Field Programmable Gate Array), or as an ASIC (Application Specific Integrated Circuit). Alternatively, (or in addition), the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

### Open Issues

As has been described, various 3GPP meeting groups have agreed to support both hard and soft satellite (SAT) switching (e.g., NTN vehicles) for UEs. However, there are many open issues that need to be resolved in order to fully support hard and soft SAT switching for UEs. A first issue is that: specific UE operations are needed to support soft SAT switching, as they do not currently exist. Further issues that need to resolved apply to common UE operations when switching to a target SAT (which are applicable for both soft and hard SAT switching) that include: a process is needed to initiate a random access channel (RACH) as the first uplink (UL) transmission for a target SAT that can be RACH-based or RACH-less; a process is needed for the network (NW) to be aware that the UE selects RACH-less SAT switching; a process is needed such that when RACH-less switching occurs a Nta value is determined for the initial UL transmission for the target SAT (e.g., Nta may correspond to a timing advance between downlink and uplink); a process is needed to handle the timing advance timer (TA Timer) during the SAT switching procedure; and a process is needed to determine any UE impact on radio resource management (RRM) measurement and radio link monitoring (RLM) operations.

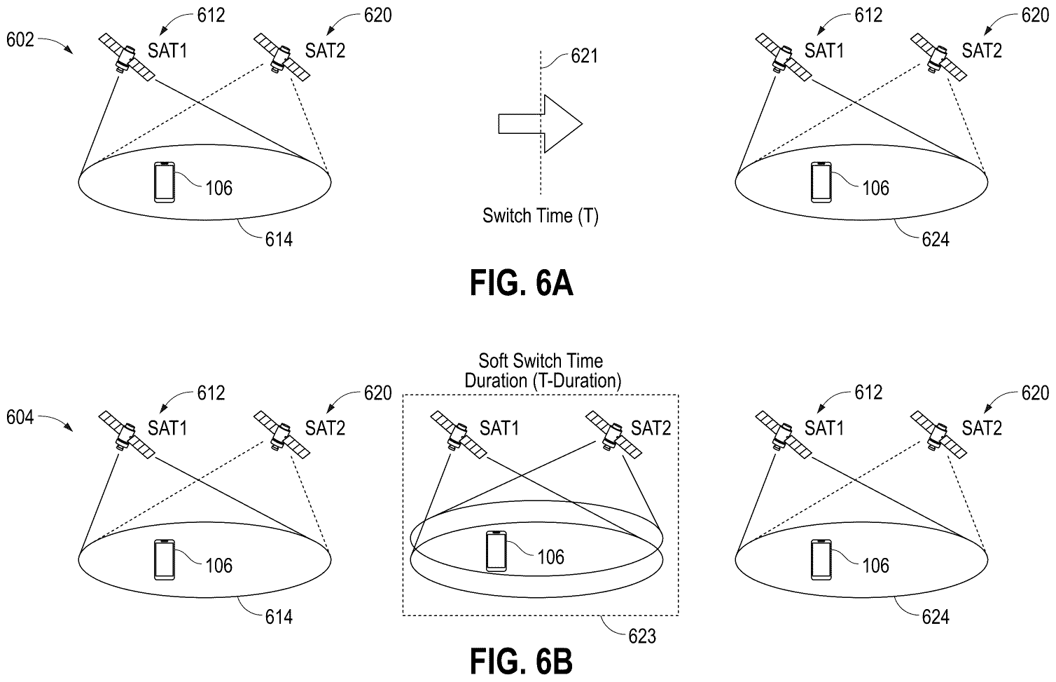

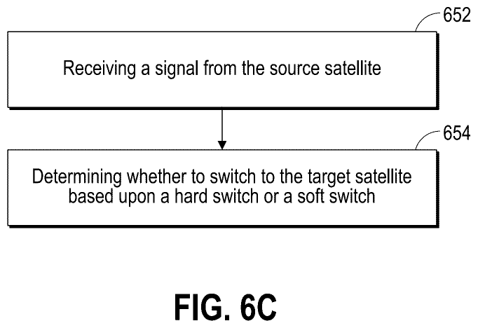

With reference to FIGS. 6A and 6B, embodiments related to hard SAT switching and soft SAT switching will be described.

As shown in FIG. 6A, a hard SAT switching example 602 is provided. In this example, UE 106 resides in a cell 614 served by SAT1 612. The serving SAT 612 may be switched at a switch time (T) 621. Before switch time (T) 621, SAT1 612 is the serving satellite and, after switch time (T) 621, SAT2 620 is the serving satellite, serving UE 106 in cell 624. This is an example of a hard switch. However, in both the hard switch and the soft switch, the serving cell can be the same regardless of serving SAT1 or SAT2, such that serving cell (cell 614 or cell 624) can be the same or different.

As shown in FIG. 6B, a soft SAT switching example 604 is provided. In this example, UE 106 resides in cell 614 served by source SAT1 612. Next, as shown in block 623, a soft switch time duration (T-duration) occurs, in which both the source SAT1 612 and target SAT2 620 both provide service/coverage for the same area for the UE 106 (i.e., overlapping cells). After, the soft SAT switch, after T-duration, target SAT2 620 is the serving satellite, serving UE 106 in cell 624. This is an example of a soft switch. However, in both the hard switch and the soft switch, the serving cell can be the same regardless of serving SAT1 or SAT2, such that serving cell (cell 614 or cell 624) can be the same or different.

It should be appreciated that these figures focus on the satellites and the UEs, and that the UEs 106 are still being serviced by the network 100 and base stations 102, as previously described. It should be appreciated that as shown in FIGS. 6A and 6B, UE 106 switches between a source SAT 612 and a target SAT 620. This provides an example of a Non-Terrestrial Network (NTN) including source SAT 612 and target SAT 620 in communication with UE 106. NTN refers to networks, or segments of networks, using an airborne or spaceborne vehicle for transmission. Examples of spaceborne vehicles include: low earth orbit (LEO) satellites, medium earth orbit (MEO) satellites, geostationary equatorial orbit (GEO) satellites, and highly elliptical orbit (HEO) satellites. Examples of airborne vehicles also include high altitude platforms (HAPS). These types of vehicles may be used address mobile broadband needs and public safety needs in unserved/underserved areas and maritime, airplane, and railway connectivity. NR NTN (especially LEO and GEO) include implicit compatibility to support HAPS and air-to-ground scenario (ATG). It should be appreciated that source SAT 612 and a target SAT 620 may be any type of the airborne and spaceborne vehicles. As will be described, UE 106 communicates with source SAT 612 and a target SAT 620. Further, base stations/gNBs 102 may also used in communication with UE 106 to communicate network data from the network 100.

### Soft SAT Switching UE Operation

Embodiments relate to a method for UE 106 to: receive a signal from the source satellite 612; and determine whether to switch to the target satellite 620 based upon hard SAT switching or soft SAT switching. In one embodiment, determining whether to switch to the target satellite 620 based upon a hard switch or a soft switch is based upon a received network configuration message from the network (e.g., option 1) or based upon a measured time gap (e.g., option 2).

As can be seen in FIG. 6C, a flowchart is provided to show a method for UE 106 in communication with source satellite 621 to switch to target satellite 620. The method includes an operation of receiving a signal from the source satellite (block 652). The method further includes the operation of determining whether to switch to the target satellite based upon a hard switch or a soft switch (block 654).

In one embodiment, UE 106 may receive an explicit network configuration message from the network 100 that a soft SAT switch or hard SAT switch is to occur by the UE. The explicit network configuration message may include the cell information and the target SAT information to perform the switch to, as well as other information. In one embodiment, this explicit network configuration message may be a system information block (SIB), and, in one particular example, may be SIB19.

In one embodiment, UE 106 may be informed by the network 100 of a soft switching period (e.g., a measured time gap) to indicate soft switching and the switching period. In this embodiment, a configuration of the soft switching period may be: 1) based on the stop time of the source SAT and the start time of the target SAT; or 2) based on an explicitly configured duration.

As an example, shown below:

As shown in this example, based on the stop time of the source SAT and the start time of the target SAT, a soft switch period can be determined. In one example, the network can provide this information in a SIB (e.g., SIB 19) of the serving cell of the source SAT before SAT switching execution to the UE 106.

Also, in one embodiment, if there is no measured time gap at all, hard SAT switching can be determined and transmitted to the UE 106 and the UE 106 can engage in hard SAT switching.

Additionally, during the soft switching period, UE 106 can start detecting the DL sync/synchronization signal block (SSB) of the target SAT 620. It is assumed that the SSB of the target SAT may be provided from NW 100 to UE 106 in advance. Further, UE 106 keeps on the data transmission to the source SAT 612 until detecting the DL sync/SSB of target SAT (or initiation of the 1st UL transmission). It is assumed that Reference Signal Received Power/Reference Signal Received Quality (RSRP/RSRQ) of the target SAT's SSB is greater than a threshold. For example, the threshold may be configured or predefined in a specification. Upon detecting the DL sync of the target SAT (or initiation of the 1st UL transmission): UE 106 stops the transmission in the source SAT and UE 106 starts to perform the transmission to the target SAT. If UE 106 fails detecting the DL sync/SSB of the target SAT within the soft switching period: UE 106 stops the transmission/reception in the source SAT. Further, UE 106 continues monitor DL sync/SSB of target SAT till the switching timer expiry or UE 106 assumes SAT switching failure and initiates the UE connection reestablishment procedure.

Also, as to UE 106 operation on both data transmission in source SAT 612 and DL sync detection in target SAT 620 during the gap switching period, there are three potential options: Option 1: When UE starts monitoring SSB of target SAT, UE stops the transmission in source SAT; Option 2: When UE starts monitoring SSB of target SAT, UE keeps the transmission in source SAT in a time division multiple TDM way, i.e., switch back to source SAT after each sync sample (e.g., SSB burst) and switch to target SAT for the new sample of DL sync/SSBs; or Option 3: may be up to a UE implementation procedure.

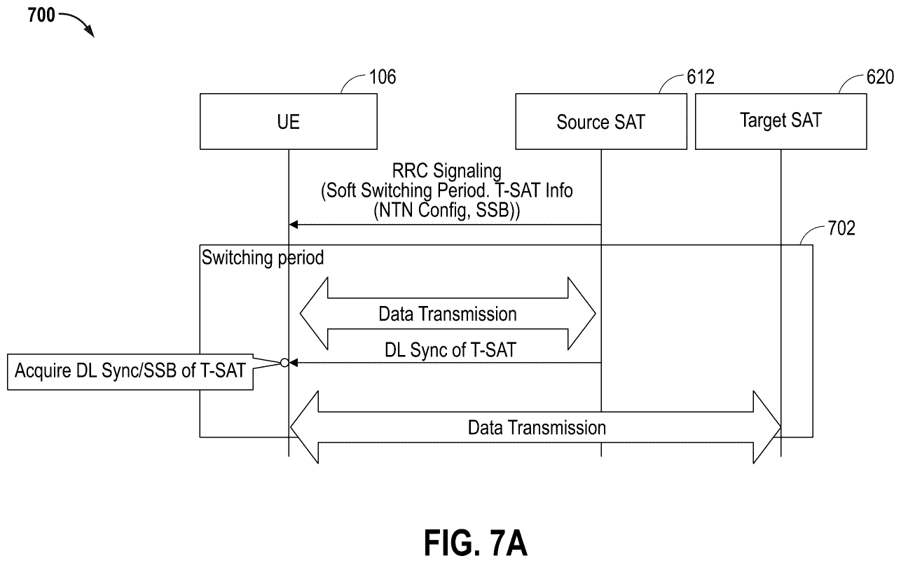

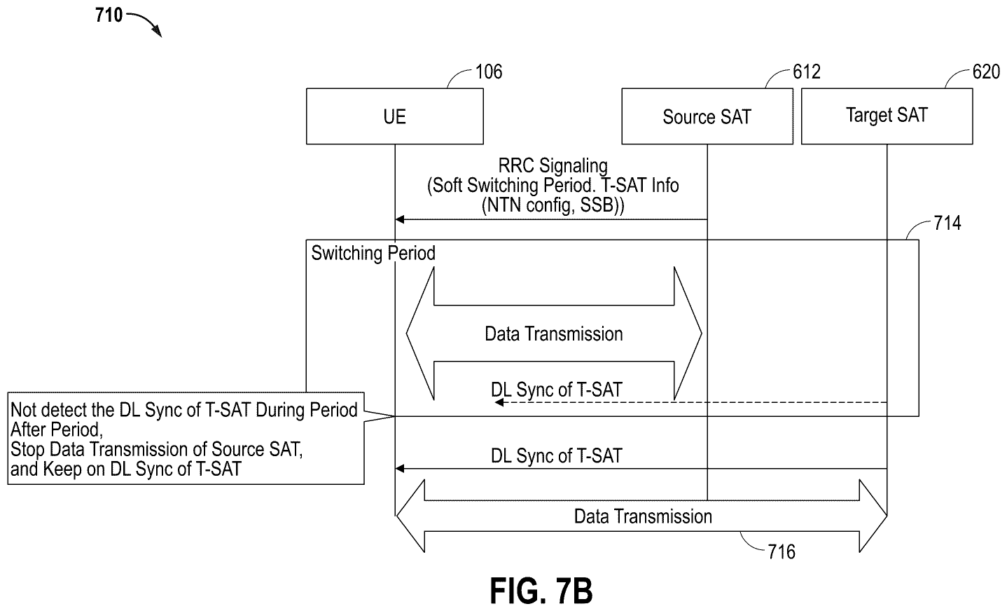

With brief reference to FIG. 7A, an example 700 of the UE switching to the target SAT during a soft SAT switching period is described. As can be seen in example 700, UE 106 receives radio resource control (RRC) signaling from the source SAT 612 cell from the network before the soft switching period. This may include information about the target SAT 620 (e.g., non-terrestrial network (NTN) configuration information, SSB, etc.). Some of this information may be included in a SIB (e.g., SIB19). During the soft switching period 702, data transmission may occur, a DL sync of the T-SAT 620 may occur, and the UE may acquire the DL sync/SSB of T-SAT 620 and data transmission may occur with T-SAT 620.

With brief reference to FIG. 7B, an example 710 of a DL sync detection failure of the target SAT during a soft SAT switching period by the UE is described. As can be seen in example 710, UE 106 receives RRC signaling from the source SAT 612 cell from the network during the soft switching period. This may include information about the target SAT 620 (e.g., NTN configuration information, SSB, etc.). Some of this information may be include in a SIB (e.g., SIB19). During the soft switching period 714, the UE may not detect or acquire the DL sync/SSB of T-SAT 620 (i.e., it may fail). In this case, after the switching period, data transmission from the source SAT 612 is stopped, and thereafter, the DL sync of the T-SAT 620 is detected and acquired, and then data transmission 716 between the UE and T-SAT 620 may occur.

### Common UE Operation During SAT Switching RACH-Less or RACH-Based

In one embodiment, a UE 106 in communication with a source satellite 612 to switch to a target satellite 620 is disclosed that comprises: switching communication from the source satellite 612 to the target satellite 620; and determining whether to utilize a random access channel (RACH)-based communication or a RACH-less communication to access the target satellite.

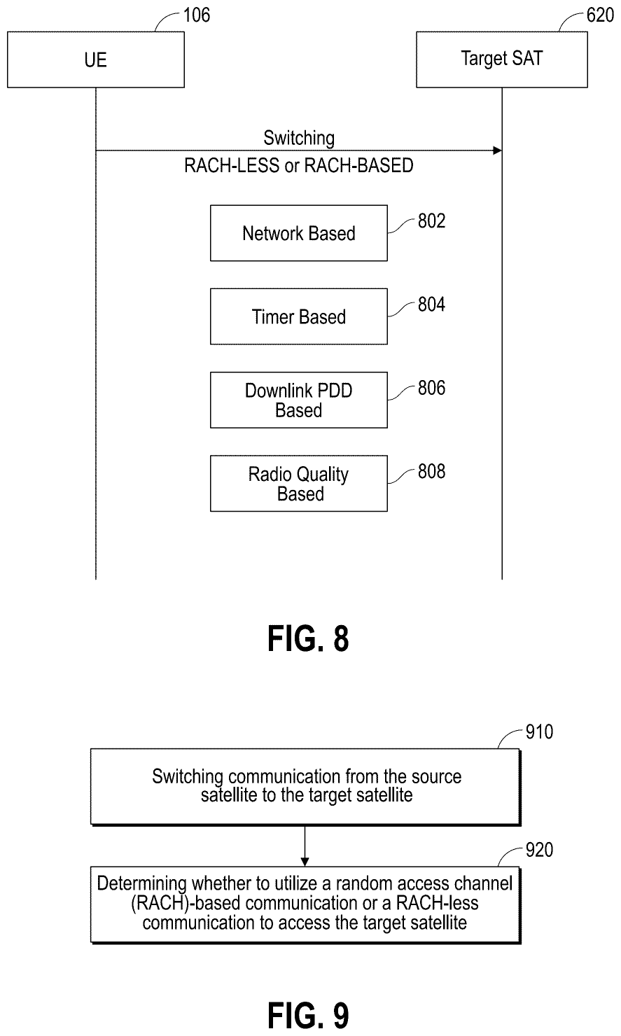

There are multiple different solution options. With brief reference to FIG. 8, a UE 106 is shown that may switch to a target SAT 620 based on RACH-less communication or RACH-based communication. For example, the RACH-less or RACH-based communication may be: network based 802; timer based 804; DL propagation delay (PDD) based 806; or radio quality based 808.

As shown in FIG. 9, a flowchart is provided to show a method for UE 106 in communication with source satellite 621 to switch to target satellite 620. The method includes an operation of switching communication from the source satellite to the target satellite (block 910). The method further includes the operation of determining whether to utilize a random access channel (RACH)-based communication or a RACH-less communication to access the target satellite (block 920).

### Based on Network Configuration

For example, if based on network configuration 802, the network explicitly indicates RACH-less or RACH-based SAT switching via RRC signaling. In one example, this may be provided by a SIB. As an example, the RACH-less or RACH-based SAT switching indicator may be via SIB19 or SIB1 or RRC dedicated signaling. The configuration may be per serving cell or per target SAT 620. If RACH-less configuration is cell specific, and UE 106 capability does not support RACH-less SAT switching, UE 106 may perform RACH-based SAT switching.

### Based on Situation of TA Timer

In the timer based 804 implementation, if a TA Timer is running, UE 106 performs RACH-less access to the target SAT 620, and UE 106 continues monitoring dynamic scheduling in target SAT 620. If TA Timer expires, UE 106 performs a RACH (RACH-based) to the target SAT after switching.

Based on DL propagation delay difference (PDD)

In the DL PDD implementation 806, based on the DL PDD of target sat 620 and source SAT 612, if PDD<threshold, then UE 106 performs RACH-less access, and initiates UL transmission towards the target SAT via the UE dedicated UL grant, and if PDD>=threshold, UE 106 starts the RACH-based access in target SAT 620.

### Based on Radio Quality

In the radio quality implementation 808, UE 106 is only allowed performing RACH-less access to target SAT 620 if the quality in target SAT>threshold.

### Network Implementations for RACH-Less SAT Switching

One feature relates to enabling the network 100 to be aware that UE 106 has selected RACH-less SAT switching. The network needs to provide the UL grant to the UE for the first UL transmission towards the target SAT.

In a first type of network operation (Network Implementation 1), the network 100 automatically assumes that UE 106 selects RACH-less SAT switching and provides the dynamic grant to UE 106 via target SAT 620. However, if UE 106 selects the RACH-based solution, UE 106 does not monitor the network scheduling a physical downlink control channel (PDCCH) until the RACH procedure is successfully completed. In this example, the dynamic grant may be wasted.

In a second type of network operation (Network Implementation 2), the network 100 delays some time to provide the dynamic scheduling if no UE based RACH preamble is received. If UE 106 is not aware of the delay time, UE monitors the PDCCH in target SAT 620 upon SAT switching. If UE 106 is aware of the delay time (T), and, if UE selects RACH-less SAT switching, the UE delays the time (T) to perform the RACH-less SAT switching. This may introduce additional interruption time for RACH-less SAT switching.

In a third type of network operation (Network Implementation 3), the network 100 provides the preconfigured grant for the initial UL transmission in target SAT 620 in advance. The network 100 provides the preconfigured grant or configured grant for target SAT in advance and is not required to provide dynamic scheduling during SAT switching. UE 106 applies the preconfigured grant for 1st UL transmission upon RACH-less SAT switching in execution. It should be noted that preconfigured grant for target SAT can be the preconfigured grant in a RACH-less handover (HO) that is provided to UE 106 in previous RRC dedicated signaling or can be the previous configured grant in source SAT 612 which can be applicable on the new target SAT 620.

### TA Timer Implementations for RACH-Less SAT Switching

In timer based implementations, an initial TA value for the first UL transmission in RACH-less SAT switching procedures is needed.

In one optional implementation, UE 106 always assume that Nta=0 for the first UL transmission in the target SAT 620.

In another optional implementation, assuming UE 106 keeps the TA Timer running during the SAT switching procedure, and the first UL transmission is based on the situation of the TA timer. For example, if the TA Timer is running, UE 106 keeps using the source cell's Nta value to calculate the TA value for the first UL transmission. Otherwise, UE 106 assumes the Nta value is 0.

In another optional implementation, the first UL transmission is based on the propagation delay difference (i.e., PDD) between the source and target SAT. For example, if the PDD does not change much, which means the source and target SAT position is similar, the DL/UL delay would be similar between source and target SAT, and source Nta value can be used. For other components to calculate the TA value for the first UL transmission, UE 106 will need to calculate. For example, as to a UE operation, if the PDD <threshold, UE 106 may use the source SAT's Nta value for initial UL transmission. Otherwise, UE 106 may use the Nta=0 value to calculate the TA value for the first UL transmission.

It should be appreciated that as to the TA values previously described, that in some embodiments, special components of UL TA value (T_{TA}) in NTN are N_{TA-UE} and N_{TA-COMMON}. (e.g., RANI Specification), that may be utilized in calculations. N_{TA-UE} is calculated based on UE position and ephemeris-info of serving satellite. (e.g., service link delay). N_{TA-COMMON} is derived according to Delay_{common}, and the calculation is based on NTN-Configuration of serving satellite. (e.g., feeder link delay). The NTN-Configuration may be used for TA calculation and is provided in NTN-config. For serving cell, NTN-config is provided in RRC dedicated config and SIB19. For neighbor cell, NTN-config is provided in SIB19. When the serving SAT of the serving cell is changed, when UE performs the SAT switching to the target SAT, UE should use the parameters for UL TA acquisition from the target SAT's config. As to UL TA maintenance procedure, NW can use TAC MAC CE to adjust N_{TA} value (common as TN and NTN cell)

Examples of related equations that may be utilized can be seen below:

FIG. 4.3.1-1: Uplink-downlink timing relation.

```
Uplink frame number i for transmission from the UE shall start T_{TA} = (N_{TA} + N_{TA,offset} + N_{TA,adj}^{common} +
N_{TA,edit}^{UE})T_{c} before the start of the corresponding downlink frame at the UE where
  N_{TA} and N_{TA,offset} are given by clause 4.2 of [5, TS 38.213], except for magA transmission on PUSCH where
    N_{TA} = 0 shall be used;
    N_{TA,adj}^{common} given by clause 4.2 of [5, TS 38.213] is derived from the higher-layer parameters
    TACommon, TACommonDrift, and TACommonDriftVariation if configured, otherwise N_{TA,adj}^{common} = 0;
    N_{TA,adj}^{UE} given by clause 4.2 of [5, TS 38.213] is computed by the UE based on UE position and serving-
    satellite-ephemeris-related higher-layers parameters if configured, otherwise N_{TA,adj}^{UE} = 0.

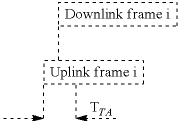

```

Using higher-layer ephemeris parameters for a serving satellite, if provided, a UE pre-compensates the two-way
transmission delay on the service link based on N_{TA,adj}^{UE} that the UE determines using the serving satellite
position and its own position. To pre-compensate the two-way transmission delay between the uplink time
synchronization reference point and the serving satellite, the UE determines N_{TA,adj}^{common} [4, TS 38.211] based
on one-way propagation delay Delay_{common}(t) that the UE determines as:
${Delay}_{common} ( t ) = \frac{{TA}_{Common}}{2} + \frac{{TA}_{CommonDrift}}{2} \times ( t - {t}_{epoch} ) + \frac{{TA}_{CommonDriftVariant}}{2} \times {( t - {t}_{epoch} )}^{2}$
where TA_{Common}, TA_{CommonDrift}, and TA_{CommonDriftVariant} are respectively provided by ta-Common,
ta-CommonDrift, and ta-CommonDriftVariant and t_{epoch} is the epoch time of TA_{common}, TA_{CommonDrift}, and
TA_{CommonDriftVariant} [12, TS 38.331]. Delay_{common}(t) provides a distance at time t between the serving satellite and
the uplink time synchronization reference point divided by the speed of light. The uplink time synchronization
reference point is the point where DL and UL are frame aligned with an offset given by N_{TA,offset}.

The TA Timer also needs to be properly controlled during SAT switching. In one example option, UE 106 keeps the TA Timer running during the switching procedure. In another example option, UE 106 maintains the TA Timer per SAT, and stops the TA Timer of the source SAT when access is made to the target SAT. In particular, for RACH-less switching, UE 106 can start the TA Timer for the target SAT upon the 1st UL transmission. For RACH-based switching, UE 106 can follow legacy operations, and start the TA Timer based on the reception of TAC MAC CE from network.

Various solutions are provided as to any UE impact on RRM measurement and RLM operation. For example, for serving cell's measurement (including L1 measurement result), when UE 106 initiates the SAT switching or decides to access the target SAT, UE 106 may reset L3 filter/RRM measurement on the serving cell and discard all the stored serving cell's measurement. For RLM, when UE 106 initiates the SAT switching or decides to access the target SAT, UE 106 resets RLM variable and all RLM timers. For neighbor cell measurement, UE 106 operation may be the same as legacy (no reset). In legacy, the measurement is initiated based on serving cell's quality (s-measure) or location.

Various solutions are provided as to medium access control (MAC) input of the SAT switching. As one example solution, if the configured grant is not applicable in target SAT, then UE 106 discards/releases the configured grant upon SAT switching. If the configured grant can be applicable in target SAT for the initial UL transmission, then UE 106 flushes the hybrid automatic repeat request (HARQ)/soft buffer of the configured grant if it's applicable in source SAT. UE 106 applies/activates the configured grant when switching to target SAT for initial UL transmission. As to HARQ operation, UE 106 flushes HARQ/soft buffer upon switching to target SAT. UE 106 initiates power headroom reporting (PHR) upon switching to target SAT. There is no impact on buffer status reporting (BSR). The ongoing scheduling request (SR) may be terminated or may be no impact. If SR procedure is not impacted, the related variable and counter may not be reset. If SR procedure is not terminated, it may be suspended during the SAT switching procedure. As to PUCCH/SRS, the configuration may be released or the transmission suspended during the SAT switching.

As previously described, a UE 106 has been disclosed that comprises: a processor, communication interfaces, an antenna, a radio, etc., in which the processor performs operations including: receiving a signal from the source satellite; and determining whether to switch to the target satellite based upon a hard switch or a soft switch. Further, a UE 106 including: a processor, communication interfaces, an antenna, a radio, etc., has been disclosed to implement a process including: switching communication from the source satellite to the target satellite; and determining whether to utilize a random access channel (RACH)-based communication or a RACH-less communication to access the target satellite.

It should be appreciated that the operations of the previously described processes in some embodiments may be performed at the UE 106 that includes: a processor, communication interfaces, an antenna, a radio, etc., to implement the previously described processes. Additionally, some the operations of the previously described processes in some embodiments may be performed at the source satellite, the target satellite, and/or at the base station (e.g., gNB), each of which may include: a processor, communication interfaces, an antenna, a radio, etc., to implement the previously described processes.

Portions of what was described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

For example, the previously described embodiment operations may be stored as instructions on a non-transitory computer readable medium for execution by a computer (e.g., a UE). The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMS, EPROMS, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

1. A method for a user equipment (UE) in communication with a source satellite to switch to a target satellite comprising:
receiving a signal from the source satellite; and
determining whether to switch to the target satellite based upon a hard switch or a soft switch.

2. The method of claim 1, wherein, determining whether to switch to the target satellite based upon a hard switch or a soft switch is based upon a received network configuration message from a network comprising an explicit indication for hard or soft switching or an implicit indication including whether a measurement gap is configured.

3. The method of claim 2, wherein the measurement gap is configured for soft switching or no measurement gap for hard switching.

4. The method of claim 2, wherein the received network configuration message from the network comprises a system information block (SIB) including information about a cell of the target satellite to perform the soft switch to.

5. The method of claim 2, wherein, during the soft switch, further comprising acquiring downlink (DL) synchronization with the target satellite.

6. The method of claim 2, wherein, when the measurement gap comprises a stop time of the source satellite that exceeds the start time of the target satellite, further comprising commanding the performing of a soft switch to a cell of the target satellite.

7. A user equipment (UE) in communication with a source satellite to switch to a target satellite comprising:
at least one antenna;
at least one radio, wherein the at least one radio is configured to communicate with the source satellite and the target satellite using the at least one antenna; and
at least one processor coupled to the at least one radio, wherein the at least one processor is configured to perform operations comprising:
receiving a signal from the source satellite; and
determining whether to switch to the target satellite based upon a hard switch or a soft switch.

8. The UE of claim 7, wherein, determining whether to switch to the target satellite based upon a hard switch or a soft switch is based upon a received network configuration message from the network comprising an explicit indication for hard or soft switching or an implicit indication including whether a measurement gap is configured.

9. The UE of claim 8, wherein the measurement gap is configured for soft switching or no measurement gap for hard switching.

10. The UE of claim 8, wherein the received network configuration message from the network comprises a system information block (SIB) including information about a cell of the target satellite to perform the soft switch to.

11. The UE of claim 8, wherein, during the soft switch, further comprising the processor commanding performing downlink (DL) synchronization with the target satellite.

12. The UE of claim 8, wherein, when the measurement gap comprises a stop time of the source satellite that exceeds the start time of the target satellite, the processor further commands the performing of a soft switch to a cell of the target satellite.

13-23. (canceled)

24. A user equipment (UE) in communication with a source satellite to switch to a target satellite comprising:
at least one antenna;
at least one radio, wherein the at least one radio is configured to communicate with the source satellite and the target satellite using the at least one antenna; and
at least one processor coupled to the at least one radio, wherein the at least one processor is configured to perform operations comprising:
switching communication from the source satellite to the target satellite; and
determining whether to utilize a random access channel (RACH)-based communication or a RACH-less communication to access the target satellite.

25. The UE of claim 24, wherein, determining whether to utilize RACH-based communication or RACH-less communication is based upon a received network configuration message from a network.

26. The UE of claim 25, wherein the received network configuration message from the network to utilize RACH-based communication or RACH-less communication is included in a system information block (SIB) or radio resource control (RRC) dedicated signaling.

27. The UE of claim 26, wherein, the RACH-based or RACH-less configuration is cell specific or target satellite specific.

28. The UE of claim 24, wherein, determining whether to utilize RACH-based communication or RACH-less communication is based upon a status of a timing advance (TA) timer.

29. The UE of claim 28, wherein, if upon determining that the TA timer is running, RACH-less access to the target satellite is performed, and
wherein, upon determining that the TA timer is expired, RACH-based access to the target satellite is performed.

30. (canceled)

31. The UE of claim 24, wherein, determining whether to utilize RACH-based communication or RACH-less communication is based upon a difference of downlink propagation delay (PDD) of the target satellite and source satellite, and
wherein, if the difference of the PDD is less than a threshold, RACH-less access of the target satellite is performed, whereas, if the difference of the PDD is greater than or equal to the threshold, RACH-based access of the target satellite is performed.

32. (canceled)

33. The UE of claim 24, wherein, determining whether to utilize RACH-based communication or RACH-less communication is based upon radio quality, and
wherein, if the radio quality of the target SAT is greater than a threshold, RACH-less access of the target satellite is performed, otherwise, RACH-based access of the target satellite is performed.

34. (canceled)
